(19) United States
(12) Patent Application Publication
(10) Pub. No.: US 2021/0190995 A1
(43) Pub. Date: Jun. 24, 2021

(54) LENS WITH AN ANTIFOG COATING AND METHOD OF MAKING SAME

(71) Applicant: SHAMIR OPTICAL INDUSTRY LTD., Upper Galilee (IL)

(72) Inventors: Uri GREEN, Alonei Habashan (IL); Zohar KATZMAN, Haifa (IL)

(73) Assignee: SHAMIR OPTICAL INDUSTRY LTD., Upper Galilee (IL)

(21) Appl. No.: 16/725,025

(22) Filed: Dec. 23, 2019

(51) Int. Cl. G02B 1/18; G02B 27/00; G02B 1/11; C03C 17/34; C03C 17/30

(52) U.S. Cl. CPC G02B 1/18; G02B 27/0006; G02B 1/11; C03C 2217/76; C03C 17/30; C03C 2217/75; C03C 17/3405

(57) ABSTRACT

A lens with antifog coating having an improved properties and methods of forming such a coating are disclosed. The lens with an antifog coating may include: a lens composed of a transparent optical material; a hydrophilic layer applied only on a first surface of the lens; and a hydrophobic nanolayer applied on top of the hydrophilic layer, In some embodiments, the hydrophobic nanolayer may be applied only on top of the hydrophilic layer applied on the first surface of the lens.

### FIELD OF THE INVENTION

The present invention relates generally to the field of optical lens coatings. More specifically, the present invention relates to the field of antifog coating for optical lenses.

### BACKGROUND OF THE INVENTION

Ophthalmic lenses are commonly coated with one or more functional coatings in order to increase at mechanical durability of the lens, optical performance of the lens and the like. Some commonly used coatings are, impact-resistant coating (impact-resistant primer), an abrasion- and/or scratch-resistant coating (hard coat), and an anti-fouling top coating. Other optional coatings include: a polarized coating, a photochromic or a dyeing coating and an anti-reflection (AR) coating. AR is one of the most commonly used coatings and is defined as a coating which improves the anti-reflective properties of an optical article when deposited at any of its surfaces. AR coatings can reduce reflection of light at the interface article-air over a relatively wide band of the visible spectrum.

An additional desired coating is the antifog coating. Antifog properties on the back and front surfaces of ophthalmic lenses in spectacles prevent condensation of water in the form of tiny droplets on the surface eyeglass lenses when the lenses are significantly cooler than the surrounding air temperature. This is commonly referred to as misting or fogging. This effect is common, for example, when corning inside from the cold. Lenses that minimize the fog are advantageous since misting of lenses impairs vision, is not aesthetic, and can cause fouling of the surface of the lenses. Preventing fog in lenses can be critical for vocations such as first responders in emergency situations, in military uses, for athletes, and workers in extreme environment conditions and the like.

The Antifog effect can be created by adjusting certain surface properties of the lens while not degrading any of the other desirable properties required of ophthalmic lenses, such as, clarity, durability, scratch resistance and the like. A preferred antifog coating will have long-lasting effect on the ophthalmic lenses. The current long-lasting solutions include forming long lasting hydrophilic coating that has low wetting/contact angle (i.e. <10 degrees) that causes the moisture from the air to spread in an even film over the surface of the lens without forming droplets.

Known in the art antifog coatings include micron size layer composed of a polymer matrix (e.g., polyurethane (PUR)) reinforced with different nanoparticles (e.g., silica-based nanoparticles), Some examples for commercially used antifog coatings include: Visguard (FSI), SAF-100 (NEI), Scotchguard (3M) and Akita SpektraShield™.

However, these known in the art antifog coatings are designed in a way that leads to a surface that is vulnerable to abrasion. Since part of the hulk polymer matrix of these antifog coatings serves as a deposit for migratory chemicals used to increase the wetting of the surface, the bulk mechanical properties and robustness of the polymer coating are compromised to some extent. These properties tend to lead to shorter lifetime due to low abrasion resistance and surface fouling, disregarding the performance of the antifogging properties.

Some attempts were made to improve the durably and cleanability of the hydrophilic coating by adding a hydrophobic layer on top of the hydrophilic coating, by dip coating, to form an antifog coating. The dip coating method results in forming the antifog coating on both the back and front sides of the lens. Accordingly, applying an additional coating, such as AR coating, on the front side of the lens is challenging. The AR coating process generates a “haze” over the accepted norm in the industry <1% since the evaporated materials interact with the antifog polymer. Furthermore, the chemical bonding formed between the hydrophilic coating and the hydrophobic layer, formed in dip coating, is limited due to (a) the nature of the chemical formulation utilized for a solvent based coating to avoid agglomeration of the active component (b) steric interference with the delivery agent, i.e. solvent chemistry, which has to be removed from the surface prior to chemical bonding of the active component.

Accordingly, there is a need for an improved antifog coating which has both good optical antifogging performance and mechanical durability. Such a coating may be applied only to one side to the lens, leaving the other side to be coated by any of the other coating disclosed herein above.

### SUMMARY OF THE INVENTION

Some aspects of the invention may be related to an antifog coating having improved properties and methods of forming such a coating. In some embodiments, the improvement of the overall performance of the permanent polymer matrix in the hydrophilic coating may include surface attachment of hydrophobic moieties allowing access to the active antifogging reservoir while repelling unwanted surface contamination and improving overall abrasion performance. A method according to some embodiments of the invention may allow coating only one side of the lens (e.g., the back side) with an antifog coating while leaving the other side (e.g., the front side) to be coated by any additional coating, such as AR coating, hard coating and the like.

A lens with an antifog coating according to some embodiments of the invention may include: a lens composed of a transparent optical material; a hydrophilic layer applied only on a first surface of the lens; and a hydrophobic nanolayer applied on top of the hydrophilic layer, In some embodiments, the hydrophobic nanolayer may be applied only on top of the hydrophilic layer applied on the first surface of the lens.

In some embodiments, the lens may further include a transparent coating applied on a second surface of the lens, the transparent coating may include at least one of: a hard coating and an antireflective coating, in some embodiments, the lens may further include a hydrophobic nanolayer applied also on top of the transparent coating.

In some embodiments, the hydrophobic nanolayer may include at least one of: fluorinated organic silicon, amino-modified silicon, mercapto-modified silicon and hydrocarbons. In some embodiments, the hydrophilic layer may include a polyurethane matrix and silica-based nanoparticles. In some embodiments, the silica-based nanoparticles are polyhedral oligomeric silsesquioxanes. In some embodiments, the hydrophilic layer has a thickness of 4-15 μm. In some embodiments, the hydrophobic nanolayer has a thickness of 2-15 nm. In some embodiments, the first surface is a back surface of the lens and the second surface is a front surface of the lens, when the lens is assembled in an optical device.

A method of forming an antifog coating of a lens according to some embodiments of the invention may include: applying a first hydrophilic layer, on a first surface of the lens; applying a plasma treatment to a free surface of the first hydrophilic layer; and applying a hydrophobic nanolayer on top of the plasma treated free surface of the first hydrophilic layer.

In some embodiments, the hydrophobic nanolayer may be composed of at least one of: fluorinated organic silicon, amino-modified silicon, mercapto-modified silicon and hydrocarbons. In some embodiments, the hydrophilic layer may include a polyurethane matrix. In some embodiments, applying the first hydrophilic layer is by spin coating. In some embodiments, the method may further include applying a second hydrophilic layer, on a second surface of the lens. In some embodiments, applying the first hydrophilic layer and the second hydrophilic layer is by dip coating. In some embodiments, the method may farther include applying a plasma treatment to a free surface of the second hydrophilic layer and applying a hydrophobic nanolayer on top of the plasma treated free surface of the second hydrophilic layer.

In some embodiments, the applied plasma treatment is at least one of: low pressure oxygen plasma treatment, a corona treatment and an atmospheric plasma oxidation treatment. In some embodiments, the hydrophobic nanolayer is applied by one of: physical vapor deposition, chemical vapor deposition and plasma assisted ionization. In some embodiments, the physical vapor deposition is conducted at: a pressure of 0.0015-0.003 Pa. In some embodiments, the plasma treatment is provided: at a pressure of no more than 3 Torr, for 1-5 minutes and the plasma is provided at capacity of 2-10 standard cubic centimeters per minute (seem) and a power of up to 400 W at 50 KHz.

In some embodiments, the method may further include edging the coated lens at least 30 minutes after the application of the hydrophobic nanolayer. In some embodiments, the method may farther include curing the first hydrophilic layer prior to the application of the plasma treatment. In some embodiments, the curing is conducted by one of: ultraviolet (UV) curing and thermal curing.

In some embodiments, the method may farther include applying an additional transparent coating on a second surface of the lens. In some embodiments, the transparent coating may include at least one of: a hard coating and an antireflective coating. In some embodiments, the method may further include applying a hydrophobic nanolayer on top of the transparent coating.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a flowchart of a method of forming an antifog coating of a lens according to some embodiments of the invention;

FIG. 1B is an illustration of a coating process of a lens according to some embodiments of the invention;

FIG. 2 is an illustration of a lens coated with an antifog coating according to some embodiments of the invention; and

FIG. 3 is an illustration of a lens coated with coatings according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, have not been described in detail so as not to obscure the invention. Some features or elements described with respect to one embodiment may be combined with features or elements described with respect to other embodiments. For the sake of clarity, discussion of same or similar features or elements may not be repeated.

Some aspects of the invention may be related to an antifog coating having an improved performance and methods of forming such a coating. Such a coating may include a combination of a hydrophilic layer applied only on at least one surface of the lens and a hydrophobic nanolayer applied on top of the hydrophilic layer. Applying the antifog coating only on one side (e.g., the back side) of the lens may enable coating the the other (e.g., front side) of the lens with a different coating. Therefore, a lens according to embodiments of the invention may include an improved antifog coating on the back side of the lens and, for example, AR coating and/or hard coating on the front side of the lens, providing each side of the lens the specific required properties.

In some embodiments, the hydrophobic nanolayer may be applied by a combination of plasma treatment (e.g., low temperature low pressure oxygen plasma treatment) and evaporation (e.g., physical vapor deposition, chemical vapor deposition and plasma assisted ionization).

A hydrophilic layer according to sonic embodiments of the invention may include a polymeric matrix, for example, a commercial blend of a PUR and polysiloxane bridges. The formulation may further include surfactants in an encapsulated form. The surfactants may be fixated and homogenously distributed in the polymeric matrix by thermal curing. The matrix may be designed to enable the migration of surfactants to the surface based on the surface surfactant concentration (i.e., le Chatelier's principle). In some embodiments, the microstructure of the hydrophilic layer may include nanoparticles, for example, Polyhedral Oligomeric Silsesquioxane (POSS), embedded in a polymeric matrix having a PUR backbone. POSS are nanostructured silica-based chemicals. In some embodiments, the application of the hydrophobic nanolayer may increase the durability of the coating, covalent bonding is formed between at least one component of the hydrophilic layer and the hydrophobic layer. In some embodiments, in order to ensure the formation of the covalent bonding, a novel method was invented. Accordingly, the POSS particles embedded in the PUR matrix may form covalent linking of a siloxane based hydrophobic moieties directly with the polymeric matrix.

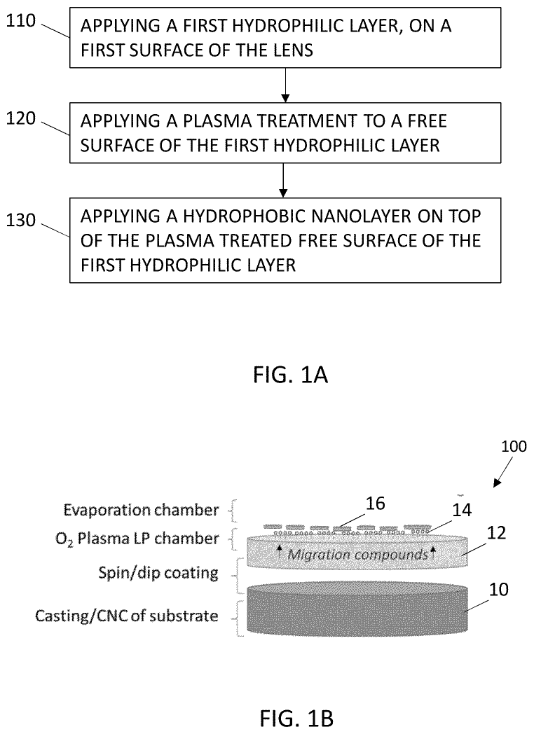

Reference is now made to FIG. 1A which is a flowchart of a method of forming an antifog coating of a lens according to some embodiments of the invention. In step 110, a first hydrophilic layer may be applied on a first surface of the lens. For example, the first hydrophilic layer may be applied by spin coating, as illustrated in FIG. 1B. In some embodiments, the spin coating may include applying a measure amount of coating material (in a liquid phase) comprising the components of the first hydrophilic to the lens and spinning or rotating the lens at high speed in order to spread the coating material by centrifugal force. The lens may be rotated until a desired thickness of the coating is archived. For example, a solution including PUR and POSS nanoparticles may be spun to coat a lens 10 as illustrated.

A lens 10 may be any lens, for example, an ophthalmic lens. The ophthalmic lens substrate is available in a vast variety of lens materials, e.g.: CR-39, Trivex, 1.56, SuperLite 1.60, SuperLite 1.67, Polycarbonate, and SuperLite 1.74, etc.

In some embodiments, hydrophilic layer 12 may include any antifog coating known in the art (e.g., any long-lasting commercial antifog coating, as disclosed herein above). For example, hydrophilic layer 12 may include a polyurethane matrix and silica-based nanoparticles (e.g., POSS).

In some embodiments, a second hydrophilic layer may also be applied on a second surface of the lens. In some embodiments, applying the first hydrophilic layer and the second hydrophilic layer is by dip coating. In some embodiments, the final thickness of the first hydrophilic layer and/or the second hydrophilic layer may be 4-15 μm.

In some embodiments, the first and/or second hydrophilic layers may be cured, using any known method, for example, ultraviolet (UV) curing, thermal curing and the like.

In step 120, a plasma treatment may be applied/provided to a free surface of the first hydrophilic layer. As used herein, a free surface of a layer is a surface that is not attached to a substance or another coating layer, and not yet coated with an additional layer. In some embodiments, the plasma treatment may be applied/provided also to a free surface of the second hydrophilic layer. In some embodiments, the plasma treatment may activate the surface of the hydrophilic layer. For example, a plasma treatment 14 (illustrated in FIG. 1B) may remove some of the PUR from the surface of layer 12, exposing the POSS siloxane particles (e.g., exposing the SiO surface of the particles). In some embodiments, the plasma treatment may be a low-pressure oxygen plasma treatment, In some embodiments the plasma treatment may include a corona treatment, atmospheric plasma oxidation treatment, and the like. In some embodiments, the low-pressure oxygen plasma treatment may be conducted at a pressure of no more than 3 Torr, for 1-5 minutes and the plasma may be provided at capacity of 2-10 standard cubic centimeters per minute (seem) and a power of up to 400 W at 50 KHz.

In step 130, a hydrophobic nanolayer may be applied on top of the plasma treated free surface of the first hydrophilic layer. In some embodiments, a hydrophobic nanolayer may also be applied on top of the plasma treated free surface of the second hydrophilic layer, In some embodiments, the hydrophobic nanolayer may be composed of at least one of: fluorinated organic silicon, amino-modified silicon, mercapto-modified silicon, hydrocarbons and the like. For example, a hydrophobic nanolayer 16 (illustrated in FIG. 1B) may be applied on top of the plasma treated free surface, in a gas phase, by one of: physical vapor deposition, chemical vapor deposition, plasma assisted ionization and the like. For example, the physical vapor deposition may be conducted at: a pressure of 0.0015-0.003 Pa. Therefore, the gas-phase based application methods, according to some embodiments of the invention, are solvent free, and may cause the evaporation of the hydrophobic coating, resulting in a cleaner, more uniform layer. This evaporation process creates more reactive molecules achieving a more permanent bond at lower temperatures. This process may be more suitable for processing with the hydrophilic layer on ophthalmic polymers <˜80° C.), than for a solvent based application method.

In some embodiments, the coated lens may be edged at least 30 minutes after the application of the hydrophobic nanolayer(s).

In some embodiments, the method may further include applying an additional transparent coating on the second surface of the lens, either instead or in addition to the second hydrophilic layer. In some embodiments, the additional transparent coating can be any transparent coating known in the art of lens coating, for example, a hard coating and an antireflective coating. In some embodiments, a hydrophobic nanolayer may be applied on top of the transparent coating, according to any one of the methods disclosed herein above.

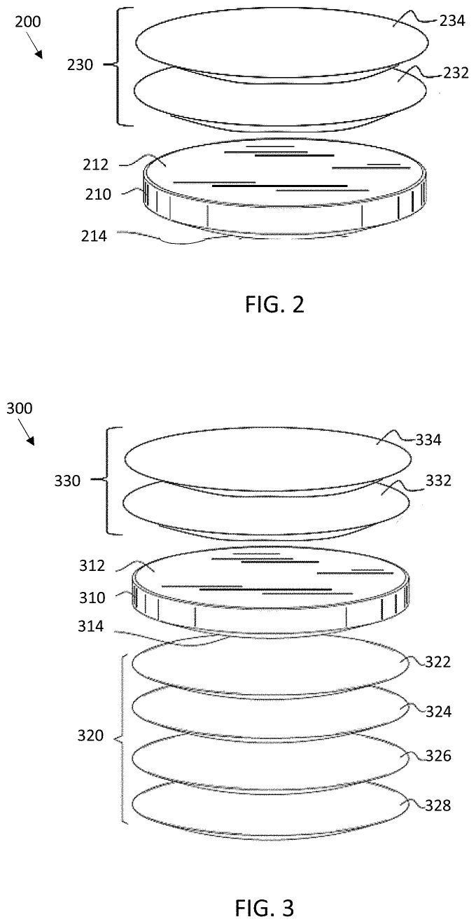

Reference is now made to FIG. 2 which is an illustration of an exploded view of a lens with antifog coating according to some embodiments of the invention. A lens 200 may include: a lens 210 composed of a transparent optical material and an antifog coating 230. Antifog coating 230 may include, a hydrophilic layer 232 applied only on a first surface 212 of lens 210 and a hydrophobic nanolayer 234 applied on top of hydrophilic layer 232. In some embodiments, hydrophobic nanolayer 234 may be applied only on top of hydrophilic layer 232 applied on first surface of the lens 212. In some embodiments, no antifog coating 230 is applied on a second surface 214. In some embodiments, only a second hydrophilic layer 232 is applied on second surface 214, as discussed with respect to FIG. 3.

In some embodiments, hydrophilic layer 232 may include any hydrophilic coating known in the art, for example, the commercial coatings: Visguard (FSI), SAF-100 (NEI), Scotchguard (3M), Akita SpektraShield™ and the like. In some embodiments, hydrophilic layer 232 may include PUR matrix and silica-based nanoparticles. In some embodiments, the silica-based nanoparticles are Polyhedral Oligomeric Silsesquioxanes embedded in the PUR matrix. In some embodiments, the thickness of hydrophilic layer 232 may be 2-30 μm, for example, 4-15 μm.

In some embodiments, hydrophobic nanolayer 234 may include at least one of: fluorinated organic silicon, amino-modified silicon, mercapto-modified silicon and hydrocarbons. In some embodiments, the siloxane functionality of hydrophobic nanolayer 234 forms covalent bonds with the silica-based nanoparticles of hydrophilic layer 232, after the exposure of the silica-based nanoparticles during a plasma treatment, as disclosed herein above in step 120 of the method of FIG. 1A. Therefore, the adhesion forces between the two layers are much stronger than any known application method in which only hydrogen or Van Der Wales bonds are formed between layers. A siloxane is a functional group in organosilicon chemistry with the Si—O—Si linkage. During the plasma evaporation process the Si functionality on the linker “head” may be active and is most stable when bonding with an Si—O surface such as the silica-based particle domains in the polymer. When both activated chemistries (linker head and the plasma treated silica nanoparticles) come in contact a stable molecular bond, “covalent bonding” is formed. In some embodiments, the thickness of hydrophobic nanolayer 234 may be 1-30 nm, for example, 2-15 nm.

In some embodiments, an additional transparent coating may be applied on second surface 214, as illustrated and discussed in FIG. 3. FIG. 3 is an illusration of a lens with antifog coating and an additional transparent coating according to some embodiments of the invention. A lens 300 may include a lens 310 composed of a transparent optical material and an antifog coating 330. Antifog coating 330 may be substantially the same as antifog coating 230 and may include, a hydrophilic layer 332 applied only on a first surface 312 of lens 310 and a hydrophobic nanolayer 334 applied on top of hydrophilic layer 332. Layers 332 and 334 may be have substantially the same dimensions and may include substantially the same materials as corresponding layers 232 and 234.

In some embodiments, lens 300 may further include an additional transparent coating 320 applied on a second surface 314 of lens 310. In some embodiments, transparent coating 320 may include at least one of: a hard coating 322 and an anti-reflection coating 324. In some embodiments, transparent coating 320 may further include at least one of: a hydrophobic nanolayer 326 applied on top of anti-reflection coating 324. In some embodiments, a grip coating 328 may be applied on top of anti-reflection coating 324 or hydrophobic nanolayer 326 to protect lens 300 during gripping in the manufacturing process. In some embodiments, hard coating 322 and antireflecting coating 324 may include any suitable corresponding coating known in the art.

In some embodiments, first surfaces 212 and 312 may be a back surface of corresponding lenses 200 and 300 and second surfaces 214 and 314 may be a front surface of corresponding lenses 200 and 300 when lenses 200 and 300 are assembled in an optical device (e.g., glasses).

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A lens with an antifog coating, comprising:
a lens composed of a transparent optical material;
an antifog hydrophilic layer comprising a polymeric matrix and migratory surfactant compounds only on a first surface of the lens; and
a first hydrophobic nanolayer, comprising fluorinated organic silicon, on top of the hydrophilic layer and bonding to the polymeric matrix of the hydrophilic layer, wherein migratory surfactant compounds remain in said hydrophilic layer.

2. The lens of claim 1, wherein the hydrophobic nanolayer is applied only on top of the hydrophilic layer applied on the first surface of the lens.

3. The lens of claim 1, further comprising a transparent coating applied on a second surface of the lens, wherein the transparent coating includes at least one of: a hard coating and an antireflective coating

4. The lens of claim 3, further comprising a second hydrophobic nanolayer applied also on top of the transparent coating.

5. (canceled)

6. The lens of claim 1, wherein the hydrophilic layer comprises a polyurethane matrix and silica-based nanoparticles.

7. The lens of claim 6, wherein the silica-based nanoparticles are polyhedral oligomeric silsesquioxanes.

8. The lens of claim 3, wherein the first surface is a back surface of the lens and the second surface is a front surface of the lens, when the lens is assembled in an optical device.

9. The lens of claim 1, wherein the hydrophilic layer has a thickness of 4-15 μm.

10. The lens of claim 1, wherein the hydrophobic nanolayer has a thickness of 2-15 nm.

11. A method of forming an antifog coating of a lens, comprising:
applying a first hydrophilic layer, on a first surface of the lens;
applying a plasma treatment to a free surface of the first hydrophilic layer; and
applying a hydrophobic nanolayer on top of the plasma treated free surface of the first hydrophilic layer.

12. The method of claim 11, wherein applying the first hydrophilic layer is by spin coating.

13. The method of claim 11, further comprising applying a second hydrophilic layer, on a second surface of the lens,
and wherein applying the first hydrophilic layer and the second hydrophilic layer is by dip coating.

14. The method of claim 13, further comprising:
applying a plasma treatment to a free surface of the second hydrophilic layer; and
applying a hydrophobic nanolayer on top of the plasma treated free surface of the second hydrophilic layer.

15. The method of claim 11, wherein the hydrophobic nanolayer is applied by one of: physical vapor deposition, chemical vapor deposition and plasma assisted ionization.

16. The method of claim 11, wherein the plasma treatment is provided: at a pressure of no more than 3 Torr, for 1-5 minutes and the plasma is provided at capacity of 2-10 standard cubic centimeters per minute (sccm) and a power of up to 400 W at 50 KHz.

17. The method of claim 11, further comprising: edging the coated lens at least 30 minutes after the application of the hydrophobic nanolayer.

18. The method of claim 11, further comprising: curing the first hydrophilic layer prior to the plasma treatment.

19. The method of claim 18, wherein the curing is conducted by one of: ultraviolet (UV) curing and thermal curing.

20. The method of claim 11, further comprising: applying an additional transparent coating on a second surface of the lens.
